(19) United States
(12) Patent Application Publication
(10) Pub. No.: US 2003/0041875 A1
(43) Pub. Date: Mar. 6, 2003

(54) Method for removing agricultural chemicals remained on surface of agricultural products

(76) Inventors: Tae-Jin Lee, Kyungki-do (KR); Soo-Jeung An, Kyungki-do (KR)

Correspondence Address: Fulbright & Jaworski, Twenty Ninth Floor, 865 South Figueroa, Los Angeles, CA, 90017-2571, US

(21) Appl. No.: 10/048,424

(22) PCT Filed: Jun. 28, 2001
(86) PCT No.: PCT/KR01/01118

(30) Foreign Application Priority Data
Jun. 28, 2000 (KR) 2000/36179
Jun. 28, 2001 (KR) 2001/37564

(51) Int. Cl. B08B 7/04

(52) U.S. Cl. 134/1; 134/25.3; 134/105

(57) ABSTRACT

The present invention relates to a method for removing agricultural chemicals that remain on the surface of agricultural products, comprising the steps treating agricultural products having residue of the agricultural chemicals with a aqueous solution for oxidizing, and thereafter or at the same time forming OH radical as a result of irradiating ultraviolet rays to agricultural treating oxidizer aqueous solution.

### CROSS REFERENCE TO RELATED APPLICATION

This application is based on application No. 2000-36179 filed in the Korean Industrial Property Office on Jun. 28, 2000, the content of which is incorporated hereinto by reference.

### BACKGROUND OF THE INVENTION

(a) Field of the Invention

The present invention relates to a method for removing agricultural chemicals remaining on the surface of agricultural products, and more particularly to a treatment of agricultural products having chemical residue with an oxidizing aqueous solution, and thereafter or at the same time forming OH radicals as a result of irradiating ultraviolet rays on the oxidizing aqueous solution.

(b) Description of the Related Art

Generally, agricultural chemicals remaining on the surface of agricultural products are easily absorbed into the human body, when the residue is not perfectly removed from the products before consumption. Typical examples of agricultural chemical residue are an organic chlorine agent, an organic phosphorus agent, and a carbamate-based agent.

Starting in the 1960's, issues of agricultural chemical residue have been addressed through enforcement of strict controls regarding registration and use of chemicals at home.

Presently, the Korea Food & Drug Administration has a permitted standard for agricultural products having agricultural chemical residue on the basis of Article 7 of the Food Sanitation Act, and the Ministry of Agriculture and Forestry has instituted safety standards of agricultural chemicals on the basis of Article 18 of the Agricultural Chemicals Control Act. But despite such acts, agricultural products that do not meet the standards do reach the market.

Because agricultural chemicals are used in excess for preventing harm to products when they are forwarded from the farm to the market, consumption of these products decreases because consumers do not trust the farms.

Agricultural chemicals remain on agricultural products by adhesion to the surface of the agricultural products, in solution in a surface layer of the product, and through permeation within the product. The chemicals generally used are mostly water-insoluble, so they are not removed well in spite of being washed with water, and it is known that over 90 percent of the chemical residue resides on the surface of the product.

Accordingly, removing agricultural chemicals remaining on the surface of agricultural products is a most important matter, and to resolve this, a method of ozonization (Ozoneskorea Co., LTD), a method of electric separation (Youllim Technology, Korea patent laid-open No. 280038), and a method of water-washing (Hodong Electron Co., LTD), is generally used.

Of these, a method of ozonization has superior treatment efficiency, but it is difficult to exhaust the ozone gas if it dissolves in water contained in the agricultural products, and as it is able to cause a bad smell and taste, it has a defect in that the range of application is very limited.

The method of electric separation comprises adding a surfactant to combine with the chemicals, and using direct current electricity to draw the surfactant/chemical combination toward an electrode. It is a difficult method to use, harmful waste-water containing an excess of agricultural chemical residue results, and it does not perfectly remove the chemicals.

Prior methods are problematic in that contaminated waste-water results, so development of new technology using little water but with superior treatment effects and easy management is demanded.

### SUMMARY OF THE INVENTION

An object of the present invention is to provide a method for removing agricultural chemicals remaining on the surface of agricultural products using an aqueous oxidizing agent solution, and forming OH radicals as a result of irradiating ultraviolet rays on the aqueous oxidizing agent solution, without effecting the quality of the agricultural products.

It is another object to provide an easily-managed method for removing agricultural chemicals that effectively treats many kinds of agricultural chemicals remaining on the surface of agricultural products.

In order to achieve these objects and others, the present invention provides a method for removing agricultural chemicals remaining on the surface of agricultural products, comprising:

a) treating agricultural products having agricultural chemical residue with an aqueous oxidizing agent solution; then

b) forming OH radicals as a result of irradiating ultraviolet rays on the aqueous oxidizing agent solution.

Also, a method for removing agricultural chemicals remaining on the surface of agricultural products of the present invention can irradiate the ultraviolet rays at the same time as the aqueous oxidizing agent solution is being applied.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1a is a front view of device for removing surface agricultural chemical residue using hydrogen peroxide and ultraviolet rays according to the present invention;

FIG. 1b is a side view of the device shown in FIG. 1a;

FIG. 2 is a graph showing change of benomyl weight of an apple by time according to a method of Comparative Example 1;

FIG. 3 is :a graph showing change of benomyl weight of an apple by time according, to a method of Comparative Example 2;

FIG. 4 is a graph showing change of benomyl weight of an apple by time according to a method of Example 1 of the present invention;

FIG. 5 is a graph showing change of benomyl weight of an apple by time according to a method of Comparative Example 3;

FIG. 6 is a graph showing change of benomyl weight of an apple by time according to a method of Example 2 of the present invention;

FIG. 7 is a graph showing change of benomyl weight of an apple by time according to a method of Example 3 of the present invention;

FIG. 8 is a graph showing change of benomyl weight of an apple by time according to a method of Example 4 of the present invention; and

FIG. 9 is a surface picture of apples for observing a change of water content thereof as a result of a method according to Example 5 of the present invention.

### DETAILED DESCRIPTION OF THE PREFERRED EMBODIMENTS

The inventor studied a method for removal of agricultural chemical residue effectively and fast with no denaturalization of a surface and state of agricultural products, in which OH radicals having strong oxidizing power and a very short half-life were formed, and completed the present invention.

The present invention treats an aqueous solution of an oxidizing agent able to form OH radicals on a surface of agricultural products, and thereafter irradiates ultraviolet rays being able to stimulate formation of OH radicals for removing agricultural chemicals remaining on the surface of agricultural products.

The aqueous solution of an oxidizing agent of the present invention does not restrict the oxidizing agent forming OH radicals during irradiation of ultraviolet rays. Preferable examples are photo catalysts of hydrogen peroxide (H₂O₂), ozone (O₃), titanium dioxide (TiO₂), and hydrogen peroxide.

The aqueous solution of an oxidizing agent can be a marketed pre-prepared product comprising an oxidizing agent dissolved in water.

A concentration of the oxidizing agent is a concentration whereby the residue amount of the active principle of agricultural chemicals can be properly treated, such that no residue remains.

When an aqueous solution of hydrogen peroxide is used as the oxidizing agent, the hydrogen peroxide content is preferably 1 to 50 percent by weight, and the treatment efficiency is controlled by injection volume. When the concentration thereof is below 1 percent by weight, the effect of removing residual agricultural chemicals may not be sufficient, and when it is more than 50 percent by weight, the removing volume of agricultural chemicals decreases.

When an active principle of agricultural chemicals exists such that it is difficult to easily distinguish, it is assumed that all associated active principle compounds used for typical agricultural chemicals or agricultural chemical formulations are present. Examples are as follows:

Group 1—Insecticide

Pyrethrin, a derris agent, a nicotine agent, a pine tree oil agent, demeton-S-methyldimethoate, ronnel, co-ral, chloropicrin, methyl bromide, hydrogen cyanide gas, a diazinon smoking agent, a dichlorvos smoking agent, terpene, methyl eugenol, dimethyl phthalate, naphthalene, etc.

Group 2—Fungicide

A lime bordeanx mixture, a mancozeb agent, a porpineb, systhane, fenarimol, 3-benzimidazole fungicide agent, etc

Group 3—Herbicide

2,4-dechlorophenoxy acetic acid, 4-2(methyl-4-chlorophenoxy)butyric acid(MCPB), propanil, sethoxydim, etc.

Additionally, regulators of plant growth including atonik, gibberellin, tomatotone, tutone, ethephon, 2,4,5-TP, maleic hydrazide, etc can be treated in the method of the present invention.

In the application of the present invention, a method for treating an aqueous solution on the agricultural products with residual active principles of agricultural chemicals can include spraying the surface with an aqueous go solution, bonding or fixing the solution on the surface of the products as an outside layer in a catalyst case, or adhering it as a capsule.

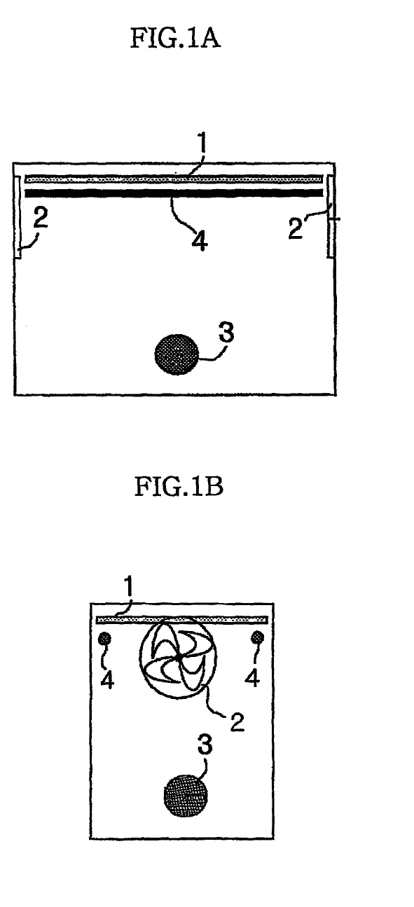

In the case of spraying and coating, device as shown in FIG. 1a or FIG. 1b can be used. FIG. 1a is a front view of spraying device, and FIG. 1b is a side view of the spraying device of FIG. 1a.

The device for removing agricultural chemical residue of the present invention as shown in FIG. 1a and 1b comprises a housing having a fixed size into which chemically contaminated agricultural products are placed, an irradiation equipment 1 installed inside at an upper part thereof, a hydrogen peroxide spraying equipment 4 placed in a lower part of the irradiation equipment 1, and a ventilation fans 2 installed at both ends of the housing.

The irradiation equipment 1 and spraying equipment 4 is installed inside and along the side walls and parallel to the same, while the ventilation fans are installed on both end walls such that they help to spread the sprayed aqueous solution on the agricultural products. The spraying of the hydrogen peroxide and irradiation of ultraviolet ways can be effectively done at the same time.

Also, the aqueous solution can be heated or cooled for a high degree of efficiency of treatment of the agricultural chemicals.

When spraying the aqueous solution of the oxidizing agent, the amount of application is preferably in the range of 0.12 to 1.08 mg per 1 cm² of a surface of the agricultural products, the amount within the range not being critical provided that an aqueous solution residue does not remain after treatment and solution particles do hot condense on the surface of the products.

Ultraviolet rays are continuously irradiated on the agricultural products with the residual chemicals that are treated with the aqueous solution of the oxidizing agent. As a result of irradiating the ultraviolet rays, the aqueous solution of the oxidizing agent forms OH radicals represented by the Formula 1, and active principle particles of the agricultural chemicals are resolved as OH radicals as represented by the Formula 2.

A major wavelength of the ultraviolet rays is preferably in the range of 180 to 380 nm such that they are able to form OH radicals, and more preferably in the range of 330 to 370 nm such that safety and efficiency are enhanced in the range of a visible ray.

H₂O₂+hυ(λ<380 nm)→2.OH [Formula 1]

.OH+M (agricultural chemical residue)→resolved products [Formula 2]

As mentioned above, treating with the aqueous oxidizing solution and then the irradiating ultraviolet rays can be done, but preferably the treatment with the aqueous oxidizing solution and the irradiation with the ultraviolet rays occurs at the same time.

The irradiation time depends on the concentration of agricultural chemicals, but the irradiation time is preferably in the range of 1 to 30 minutes because of an increased risk of denaturalization of physical and chemical characteristics of the agricultural products when the time thereof is more 30 minutes.

Additionally, the irradiation time is preferably that at which all the chemical residue is just treated, and it is also preferably that this coincides with the time it takes to perfectly evaporate all minute droplets of the aqueous solution of the oxidizing agent. As an example, in the case of treating an apple, it is preferable to spray the aqueous solution and thereafter irradiate the ultraviolet rays for 14 minutes.

However, once all of the aqueous solution of the oxidizing agent applied to the, surface of the agricultural products is exhausted, that is, the OH radicals are exhausted, the active principles of agricultural chemicals do not further decompose. Therefore spraying of the aqueous solution at regular intervals can maintain formation of the radicals. Specifically, the time of applying the aqueous solution of the oxidizing agent in the range of 0.12 to 1.08 m/cm² is preferably 5 to 10 minutes, and the time of applying the aqueous solution at 2 m/cm² is preferably less than 20 minutes.

Also, the time of treatment can be calculated by evaluating the remaining amount of active principles of agricultural chemicals. For example, the maximum permissible concentration of benomyl when it is used on a 150 g apple with a diameter of 7 cm is 2 ppm. When 90% of it remains as residue, that translates to 1.754 μg of benomyl per 1·cm², and a required time of treatment will be about 14 minutes.

With this method, agricultural chemicals remaining on the surface of agricultural products can be perfectly decomposed by spraying an aqueous solution of an oxidizing agent and irradiating the same with ultraviolet rays. It can decrease an excessive residual concentration of agricultural chemical residue to a permissible level, or it can completely decompose and remove all traces of the chemicals.

The following examples further illustrate the present invention.

### EXAMPLES

The following examples and comparative examples used an apple from Korea with a diameter of 7 cm and a weight of 15 g as the object of treatment, and VENOMIL (DONGBUHANNOBG Co, LTD.: venomyl in an amount of 50 percent by weight, interfacial active agent, limiting agent, diluent as an annex to a total of 50 percent by weight), a benzoimidazol-based fungicide, as the agricultural chemical.

### Comparative Example 1

### Change of Benomyl Weight on the Surface of an Apple Without Treatment

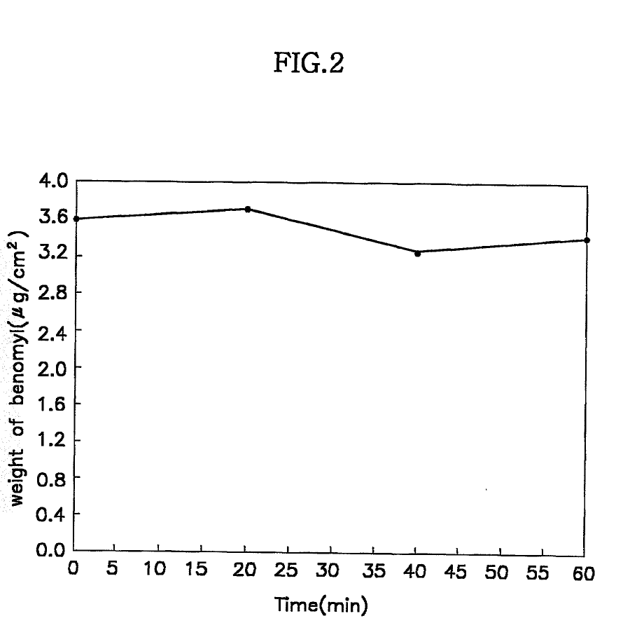

The weight of benomyl by time is shown in Table 1 and FIG. 2, with no treatment.

TABLE 1

| Time (min) | 0 | 10 | 20 | 30 |
|---|---|---|---|---|
| Weight of benomyl (μg/cm²) | 3.6 | 3.7 | 3.2 | 3.4 |

As shown in Table 1 and FIG. 2, there was no consequential weight change over time.

### Comparative Example 2

### Change of Benomyl Weight on the Surface of an Apple Treated Only with a 20% Aqueous Solution of Hydrogen Peroxide

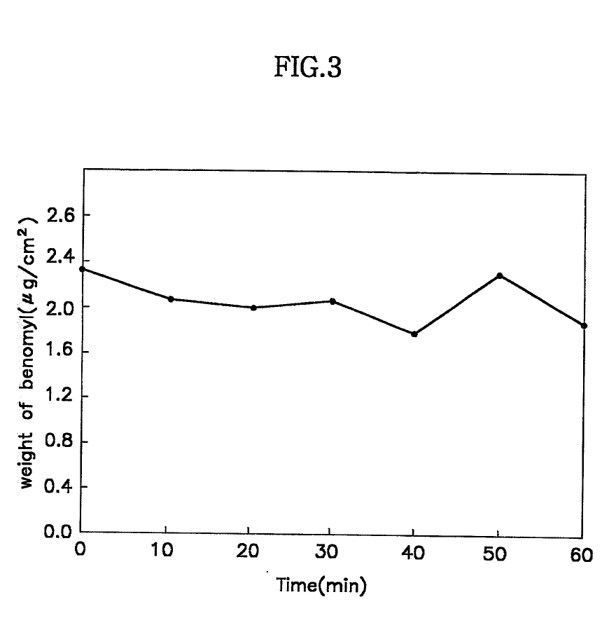

A 20% aqueous solution of hydrogen peroxide was sprayed on the apple, the weight of benomyl by time was measured, and the results are shown in Table 2 and FIG. 3.

TABLE 2

| Residual time (min) | 0 | 5 | 10 | 15 | 20 | 25 | 30 |
|---|---|---|---|---|---|---|---|
| Weight of benomyl (μg/cm²) | 2.2 | 1.98 | 1.96 | 2.0 | 1.63 | 2.38 | 1.8 |

As shown in Table 2 and FIG. 3, there was little reduction in benomyl weight.

### Example 1

### Change of Benomyl Weight on the Surface of an Apple Treated with a 20% Aqueous Solution of Hydrogen Peroxide and with Ultraviolet Rays

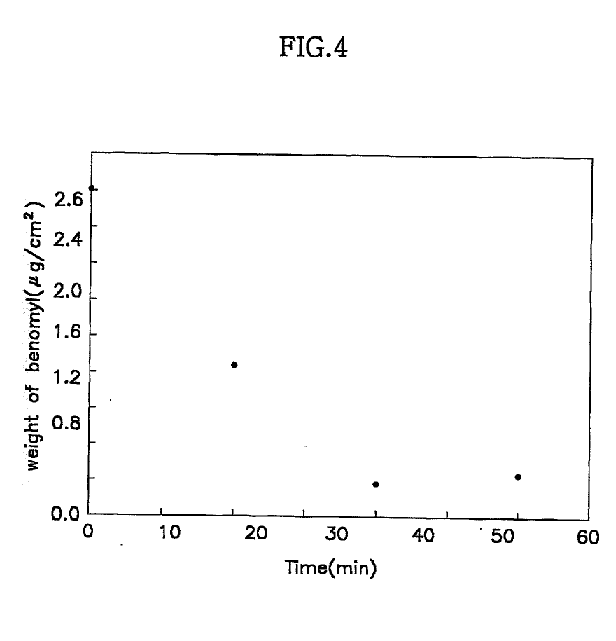

A 20% aqueous solution of hydrogen peroxide was applied to the surface of the apple using the spray device shown in FIG. 1, ultraviolet rays at 350 nm were irradiated thereon, and the weight of benomyl by time was measured. The results are shown in Table 3 and FIG. 4

TABLE 3

| Spraying time (min) | 0 | 10 | 20 | 30 |
|---|---|---|---|---|
| Weight of benomyl (g) | 1.86 | 0.82 | 0.18 | 0.24 |

As shown in Table 3 and FIG. 4, the method for removal of residual agricultural chemicals of the present invention massively decreased the weight of the benomyl.

### Comparative Example 3

### Change of Benomyl Weight on the Surface of an Apple Only Irradiated with Ultraviolet Rays (350 nm)

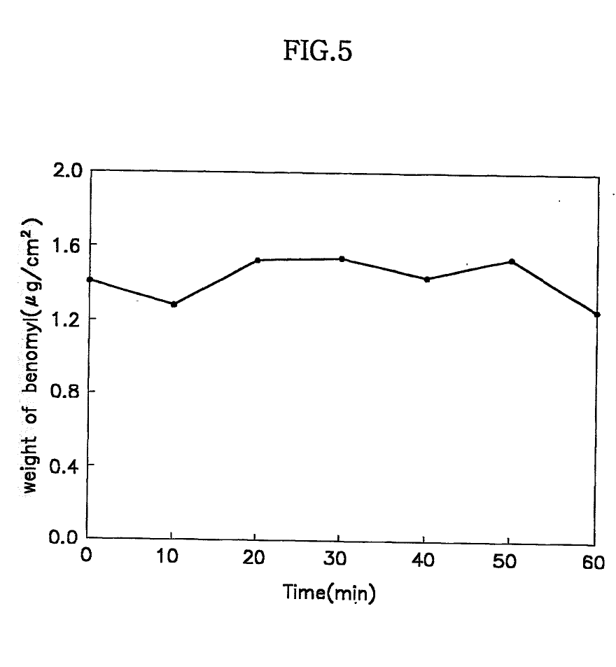

Ultraviolet rays at 350 nm were irradiated on the apple, and the change of weight of the benomyl by time was measured. The results are shown in Table 4 and FIG. 5.

TABLE 4

| Irradiation time (min) | 0 | 5 | 10 | 15 | 20 | 25 | 30 |
|---|---|---|---|---|---|---|---|
| Weight of benomyl | 1.4 | 1.25 | 1.58 | 1.6 | 1.55 | 1.58 | 1.26 |
| (μg/cm²) | | | | | | | |

As shown in Table 4 and FIG. 5, there was little weight reduction.

### Example 2

### Removal Efficiency of Benomyl on the Surface of an Apple by Concentration of Hydrogen Peroxide

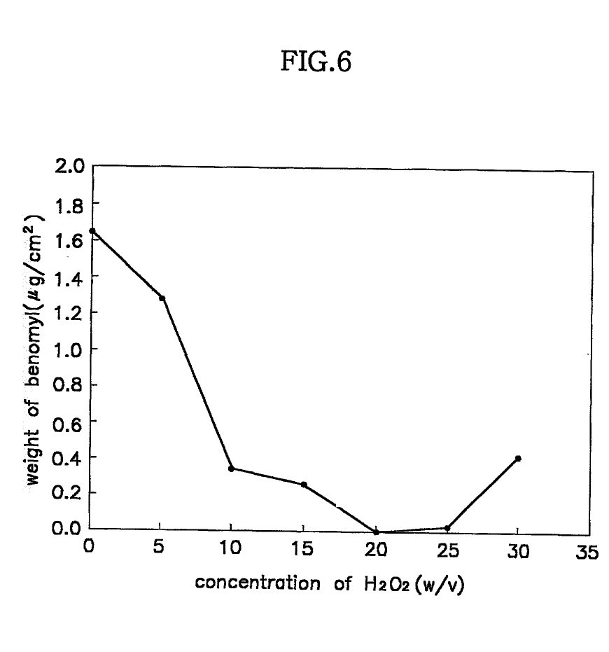

The removal amount of benomyl was measured with respect to various hydrogen peroxide concentrations, and the results are shown in Table 5 and FIG. 6.

TABLE 5

| Concentration of H₂O₂ | | | | | | | |
|---|---|---|---|---|---|---|---|
| (w/v, %) | 0 | 5 | 10 | 15 | 20 | 25 | 30 |
| Weight of benomyl | 1.65 | 1.29 | 0.39 | 0.24 | 0.0 | 0.03 | 0.41 |
| (μg/cm²) | | | | | | | |

As shown in Table 5 and FIG. 6, the weight of benomyl decreased over the hydrogen peroxide concentration range to a point of perfect removal at a 20% hydrogen peroxide concentration, at which point a further increase in concentration increased the benomyl weight.

### Example 3

### Change of Benomyl Weight on the Surface of an Apple Treated with a 20% Aqueous Solution of Hydrogen Peroxide and Ultraviolet Rays

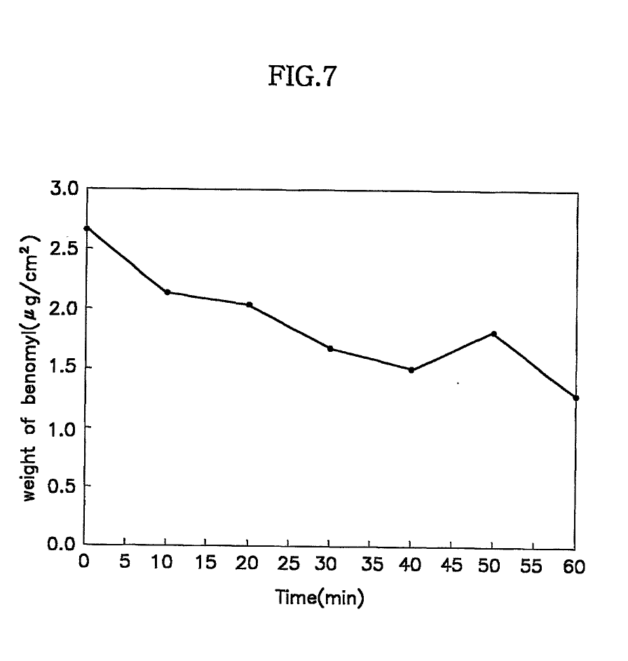

The procedure of Example 3 was the same as in Example 1, except that the 20% hydrogen peroxide solution was irradiated with ultraviolet rays at 254 nm. The results are shown in Table 6 and FIG. 7.

TABLE 6

| Residual time (min) | 0 | 5 | 10 | 15 | 20 | 25 | 30 |
|---|---|---|---|---|---|---|---|
| Weight of benomyl (μg/cm²) | 2.7 | 2.2 | 2.1 | 1.65 | 1.52 | 1.8 | 1.3 |

As shown in Table 6 and FIG. 7, it was known to an efficiency of removing.

### Example 4

### Change of Benomyl Weight on the Surface of an Apple Treated with a 20% Aqueous Solution of Hydrogen Peroxide, Thereafter Irradiated with Ultraviolet Rays at a Wavelength of 350 nm, and then Re-Sprayed with a 20% Aqueous Solution of Hydrogen Peroxide

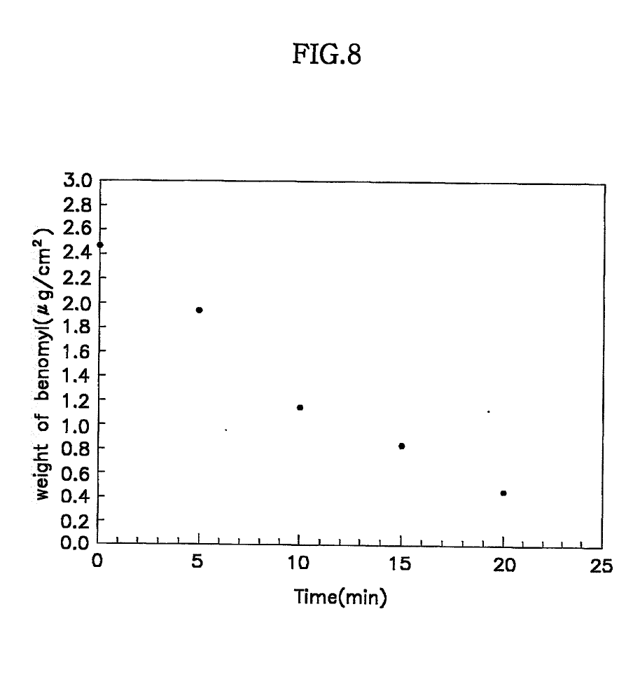

The procedure of Example 3 was the same as in Example 1, except that the apple was re-sprayed with hydrogen peroxide a certain amount of time after irradiation. The results are shown in Table 7 and FIG. 8.

TABLE 7

| Re-spraying time (min) | 0 | 5 | 10 | 15 | 20 |
|---|---|---|---|---|---|
| Weight of benomyl (μg/cm²) | 2.5 | 1.88 | 1.17 | 0.80 | 0.48 |

As shown in Table 7 and FIG. 8, removal efficiency increases when re-spraying every 5 minutes. This method shows a 47 percent efficiency increase compared with no re-spraying.

Accordingly, it is known that perfect removal of an active principle of agricultural chemicals on the surface of agricultural products results when the aqueous hydrogen peroxide solution is re-sprayed and the term of ultraviolet irradiation is controlled.

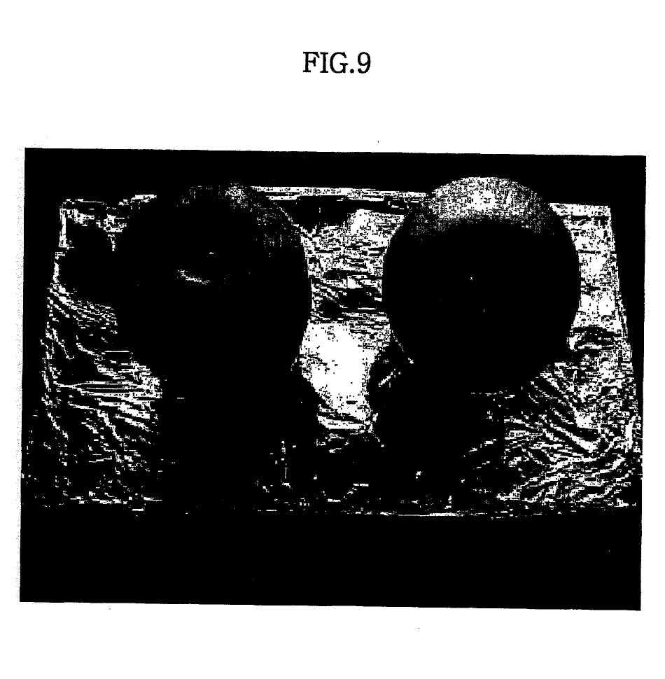

In Example 5, the surface of an apple was irradiated for 15 minutes. The results are shown in FIG. 9. As the figure shows, there was no change in water content, and there was no physical or chemical denaturalization. Therefore, the method of the present invention does not negatively affect the quality of agricultural products, and it effectively removes agricultural chemicals on the surface of agricultural products.

As mentioned above, the removal method of agricultural chemicals remaining on the surface of agricultural products using an aqueous oxidizing solution and OH radicals developed as a result of irradiating ultraviolet rays on the aqueous oxidizing solution is able to effective and easily remove agricultural chemicals from the surface of agricultural products, and maintain good quality of the agricultural products in such aspects as water content.

What is claimed is:

1. A method for removing agricultural chemicals remaining on the surface of agricultural products, comprising:
a) treating agricultural products having agricultural chemical residue with an aqueous oxidizing agent solution; then
b) forming OH radicals as a result of irradiating ultraviolet rays on the aqueous oxidizing agent solution.

2. A method for removing agricultural chemicals remaining on the surface of agricultural products of claim 1, wherein the aqueous oxidizing agent solution is selected from the group consisting of hydrogen peroxide, ozone, and titanium dioxide.

3. A method for removing agricultural chemicals remaining on the surface of agricultural products of claim 1, wherein the aqueous oxidizing agent solution is an aqueous solution of hydrogen peroxide in a concentration of 1 to 50 percent by weight.

4. A method for removing agricultural chemicals remaining on the surface of agricultural products of claim 1, wherein the aqueous oxidizing agent solution is applied by a method of spraying, coating, bonding, fixing, or adhering it onto the agricultural products.

5. A method for removing agricultural chemicals remaining on the surface of agricultural products of claim 1 wherein the ultraviolet rays have a major wavelength in the range of 180 to 380 nm.

6. A method for removing agricultural chemicals remaining on the surface of agricultural products of claim 1, wherein the ultraviolet rays are irradiated for 1 to 30 minutes.

7. A method for removing agricultural chemicals remaining on the surface of agricultural products of claim 1, wherein the steps a) and b) are repeated.

8. A method for removing agricultural chemicals remaining on the surface of agricultural products, comprising: a) treating agricultural products having agricultural chemical residue with an aqueous oxidizing agent solution; and at the same time b) forming OH radicals as a result of irradiating ultraviolet rays on the aqueous oxidizing agent solution.

9. A method for removing agricultural chemicals remaining on the surface of agricultural products of claim 8, wherein the aqueous oxidizing agent solution is selected from the group consisting of hydrogen peroxide, ozone, and titanium dioxide.

10. A method for removing agricultural chemicals remaining on the surface of agricultural products of claim 8, wherein the aqueous oxidizing agent solution is an aqueous solution of hydrogen peroxide in a concentration of 1 to 50 percent by weight.

11. A method for removing agricultural chemicals remaining on the surface of agricultural products of claim 8, wherein the aqueous oxidizing agent solution is applied by a method of spraying, coating, bonding, fixing, or adhering it onto the agricultural products.

12. A method for removing agricultural chemicals remaining on the surface of agricultural products of claim 6, wherein the ultraviolet rays have a major wavelength in the range of 180 to 380 nm.

13. A method for removing agricultural chemicals remaining on the surface of agricultural products of claim 8, wherein the ultraviolet rays are irradiated for 1 to 30 minute s.

14. A method for removing agricultural chemicals remaining on the surface of agricultural products of claim 8, wherein the steps a) and b) are repeated.

15. Device for removing agricultural chemicals, comprising;
a) a housing having a fixed size, into which chemically contaminated agricultural products are placed;
b) an irradiation equipment installed inside at an upper part of the housing;
c) a hydrogen peroxide spraying equipment placed in a lower part of the irradiation equipment; and
d) a ventilation fan installed at each end of the housing.
